(19) United States
(12) Patent Application Publication
(10) Pub. No.: US 2022/0122105 A1
(43) Pub. Date: Apr. 21, 2022

(54) SYSTEMS AND METHODS FOR MARKET CONNECTIVITY ASSESSMENT

(71) Applicant: Fifth Third Bank, Cincinnati, OH (US)

(72) Inventors: Ross W. Frisbie, Cincinnati, OH (US); Arthur E. Weston, Union, KY (US); Timothy N. Spence, Cincinnati, OH (US); David S. Jordan, Ludlow, KY (US); Eric W. Meyer, Cincinnati, OH (US)

(21) Appl. No.: 16/949,131

(22) Filed: Oct. 15, 2020

(51) Int. Cl. G06Q 30/02; G06Q 10/06

(52) U.S. Cl. CPC G06Q 30/0205; G06Q 10/06375; G06Q 10/06315

(57) ABSTRACT

Systems and methods for market connectivity assessment are disclosed. In an example method, population data and distance data for a plurality of geographical areas may be input to a model to determine predicted population migration data indicating predicted population migrations between the plurality of geographical areas. An indication of a first geographical area of the plurality of geographical areas may be received. A second geographical area may be determined based on the predicted population migration between the first and second geographical areas and the connectivity metric associated with the second geographical area.

### TECHNICAL FIELD

This disclosure generally relates to commercial markets and, more particularly, to market connectivity assessment.

### BACKGROUND

Many large-scale companies or businesses, across a range of industries, operate a network of branches or other types of business locations that covers multiple markets (e.g., cities), or at least contemplate doing so. When assessing whether to deepen the company's presence in a certain market or expand the company's footprint to new markets, a wide range of criteria exist. Many of these criteria are industry specific, which is why the number of bank branches that a market can support is different from the number of fast-food restaurants, or the number of grocery stores, and so forth. Since so many of the criteria for assessing the attractiveness of opening new branches in additional or existing markets varies by industry, it remains a challenge to formulate a universal metric that is useful across multiple industries.

These and other shortcomings are addressed in the present disclosure.

### SUMMARY

Disclosed herein are systems and methods for assessing market connectivity.

In an example method, population data may be received that indicates respective populations of a plurality of geographical areas (e.g., markets). Distance data may also be received that indicates the respective distances between the plurality of geographical areas. The population data and the distance data may be input to a model to determine predicted population migration data indicating predicted population migrations between the plurality of geographical areas. An indication of a first geographical area of the plurality of geographical areas may be received. A second geographical area may be determined based on the predicted population migration between the first geographical area and the second geographical area and the connectivity metric associated with the second geographical area.

In another example method, population data may be received that indicates respective populations of a plurality of geographical areas (e.g., markets). Distance data may also be received that indicates the respective distances between the plurality of geographical areas. The distance data and the population data may be input to a model to determine predicted population migration data indicating predicted population migrations between the plurality of geographical areas. Measured population migration data may be received that indicates respective population migrations between the plurality of geographical areas. For each geographical area of the plurality of geographical areas, one or more predicted population migrations associated with the geographical area and one or more corresponding measured population migrations associated with the geographical area may be compared. A report may be generated indicating any geographical areas of the plurality of geographical areas for which a difference between the one or more predicted population migrations associated with the geographical area and the one or more corresponding measured population migrations associated with the geographical area exceeds a threshold value.

Implementations of any of the described techniques may include a method or process, an apparatus, a device, a machine, a system, or instructions stored on a non-transitory computer-readable storage device. The details of particular implementations are set forth in the accompanying drawings and description below. Other features will be apparent from the following description, including the drawings, and the claims.

### BRIEF DESCRIPTION OF DRAWINGS

The accompanying drawings, which are incorporated in and constitute a part of this specification, illustrate embodiments and together with the description, serve to explain the principles of the methods and systems:

FIG. 1 illustrates an example schematic map diagram according to an embodiment of the present disclosure;

FIG. 2 illustrates an example system and network configuration according to an embodiment of the present disclosure;

FIG. 3 illustrates an example block process diagram according to an embodiment of the present disclosure;

FIG. 4 illustrates an example block process diagram according to an embodiment of the present disclosure;

FIG. 5 illustrates an example map diagram according to an embodiment of the present disclosure;

FIG. 6 illustrates an example graph diagram according to an embodiment of the present disclosure;

FIG. 7 illustrates an example method flow diagram according to an embodiment of the present disclosure; and

FIG. 8 illustrates an example method flow diagram according to an embodiment of the present disclosure.

Aspects of the disclosure will now be described in detail with reference to the drawings, wherein like reference numbers refer to like elements throughout, unless specified otherwise.

### DETAILED DESCRIPTION

The systems and methods of the present disclosure relate to market connectivity assessment. For example, a business entity operating a network of branches may wish to consider additional markets for expansion. According to the techniques described herein, the business entity may assess the connectivity of the various available markets and thereby identify those markets that are most attractive for expansion.

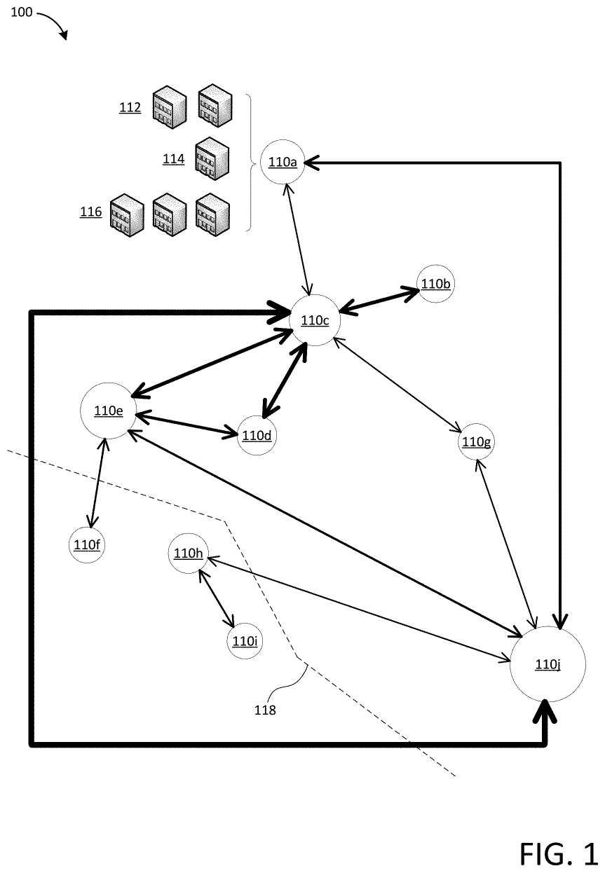

FIG. 1 illustrates a schematic map diagram 100 of a plurality of markets 110a-j (referred to generically as a market 110 or markets 110, unless referring to a specific market). The markets 110 are positioned in the diagram to generally reflect their relative geographical positioning, including the relative distances between the markets 110. The sizes of the circular representations of the markets 110 reflect their respective populations. For example, the market 110j has a larger population than the market 110i.

The double-ended arrow lines between some of the markets 110 indicate population migrations (e.g., above a minimum threshold) between those markets 110. The thickness of a line is proportional to the degree of population migration between the markets 110. For example, the population migration between the market 110c and the market 110d is greater than the population migration between the market 110c and the market 110g. As used herein, population migration refers to a change in residence from one market 110 to another. The double-ended arrow lines in FIG. 1 represent the bi-directional population migration as a single aggregate representation. Population migration may be additionally or alternatively measured as single-direction migrations from one market to another market, and the techniques and concepts described herein are equally applicable to both forms.

The markets 110 are divided by a state line 118, such that the markets 110f, 110h, and 110i are in one state and the remaining markets 110 are in another state. Whether two markets 110 are located in different states may often affect the population migration between those two markets 110, all else being equal or substantially equal. For example, where two markets 110 are located in different states, this tends to have a negative effect on the population migration between the two markets 110.

A market 110 (also referred to as a geographical area) may be defined according to various types of political borders or divisions, such as by city, county, or other municipality. A market 110 may be additionally or alternatively defined by metropolitan area, such as a metropolitan statistical area (MSA) designated by the U.S. Office of Management and Budget (OMB). A market 110 may be additionally or alternatively defined according to a relevant industry standard.

Each market 110 may have one or more branches associated with respective business entities. Several branches in the market 110a are shown for illustrative purposes. The two branches 112 may be associated with (e.g., part of a branch network of) a first business entity, the single branch 114 may be associated with a second business entity, and the three branches 116 may be associated with a third business entity. In practice, a business entity may have dozens or even hundreds of branches in a single market 110. Conversely, a business entity may have no branches in a particular market 110 at all.

A branch may refer generally to a business location. A branch may comprise a retail location offering goods or services to consumers, such as a bank, grocery store, restaurant, or department store. A branch may additionally or alternatively conduct business-to-business operations, particularly in those industries in which it may be advantageous for an entity to operate multiple branches in a market, such as building or office supplies.

The present disclosure describes techniques by which a business entity may assess the attractiveness of opening additional branches in a market 110, expanding to a market 110 in which the entity does not currently have any branches, or even reducing the number of branches in a market 110. For example, the first business entity associated with the branches 112 may determine to open additional branches 112 in the market 110c according to the techniques described herein. A system may identify the market 110c as an attractive market 110 for expansion based on the respective populations of the markets 110, the distances between the markets 110, and a model configured to determine predicted population migrations between the markets 110 based on said populations and distances. The system may determine a connectivity metric for each market 110 based on the predicted population migrations. Using the connectivity metrics and the predicted population data, the system may identify the market 110c as an attractive market for the first business entity to open additional branches 112.

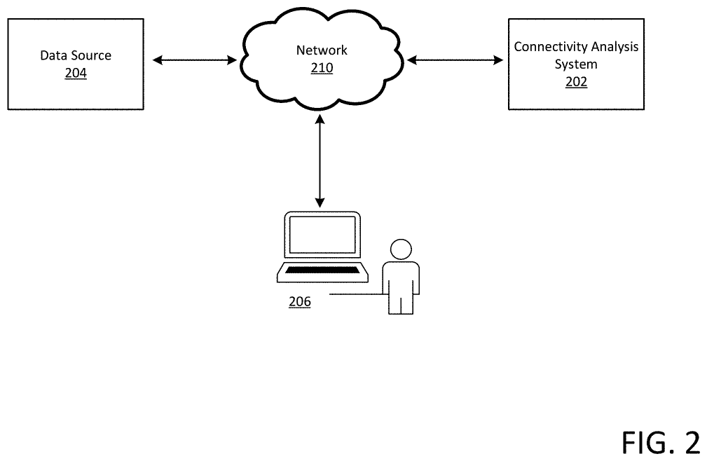

FIG. 2 illustrates an example hardware and network configuration in which the systems and methods described herein may be implemented. Such a hardware and network configuration includes a connectivity analysis system 202, a data source 204, and a user (computing) device 206. The connectivity analysis system 202, the data source 204, and the user device 206 are in mutual communication via a network 210. The connectivity analysis system 202 may be associated with a business entity (e.g., a company). Such business entity may have a branch network spread over one or more markets, or the business entity may have not yet opened any branches and is seeking the most attractive market(s) in which to open its first branch(es).

The connectivity analysis system 202 may implement a number of the functions and techniques described herein. For example, the connectivity analysis system 202 may receive, from the data source 204, population data indicating the current and/or historical populations of two or more markets (e.g., the markets 110 of FIG. 1), distance data indicating the current and/or historical distances between said markets, and historical (i.e., measured) population migration data indicated historical populations migrations between the markets.

The connectivity analysis system 202 may input the current populations and distances to a model to determine predicted population migration data for each pair of markets. The connectivity analysis system 202 may have determined the model (e.g., a regression analysis model) based on historical populations, distances, and population migrations. The connectivity analysis system 202 may determine a connectivity metric for each market based on the predicted population migration data. The connectivity analysis system 202 may output, responsive to an input of a first market, a report indicating a second market, which is preferably an attractive market for the entity to open a new branch. The connectivity analysis system 202 may determine the second market based on the predicted population migration between the first and second markets and the connectivity metric for the second market. The first market may be a market in which the entity already has one or more branches.

The connectivity analysis system 202 may additionally or alternatively receive measured population migration data and compare the predicted population migration data to the measured population migration data. The connectivity analysis system 202 may generate a report indicating any markets for which the difference between the measured population migration and the predicted population migration data exceeds a threshold. The connectivity analysis system 202 may perform a similar analysis with respect to a predicted connectivity metric and a measured connectivity metric. A market indicated in the report may be a “magnetic” market in which one or more additional features of the market cause greater population migration and/or connectivity than would be expected given the market's population, the distances between the market and other markets, and/or other factors. The additional features may be known or unknown at the time of the report. For example, the report may prompt the business entity to perform an analysis of the market and its features. As such analyses are conducted, market features that explain previously unaccounted-for variations between predicted and actual population migrations might be identified. Such features, which are preferably quantifiable for all markets, may then be added as an additional input to the model to improve the predictive power of the predicted population migrations.

As noted, the data source 204 may provide the population data, distance data, and population migration data to the connectivity analysis system 202. In some aspects, the data source 204 may be integrated with the connectivity analysis system 202. The data source 204 may be associated with a government entity. For example, population data may be provided by the relevant census bureau.

The connectivity analysis system 202 and the data source 204 may each comprise one or more computing devices and/or network devices. For example, the connectivity analysis system 202 and the data source 204 may each comprise one or more networked servers. The connectivity analysis system 202 and the data source 204 may each comprise a data storage device and/or system, such as a network-attached storage (NAS) system.

The user device 206 may comprise a personal computer, a mobile device, a laptop computer, or other computing device via which a user may provide an input and receive an output. For example, a user may input, via the user device 206, one or more markets to the connectivity analysis system 202, such as one or more markets in which the associated business entity has branches, and one or more markets that the business entity considers as candidates for opening a new branch. The user device 206 may output a report generated by the connectivity analysis system 202 indicating one or more of the latter markets that the system has determined as attractive market(s) for the business entity. In some aspects, the user may interact with the connectivity analysis system 202 directly.

The network 210 may comprise one or more public networks (e.g., the Internet) and/or one or more private networks. A private network may include a wireless local area network (WLAN), a local area network (LAN), a wide area network (WAN), a cellular network, or an intranet. The network 210 may comprise wired network(s) and/or wireless network(s).

As noted, the data source 204, the connectivity analysis system 202, and the user device 206 may each be implemented in one or more computing devices. Such a computing device may comprise one or more processors and memory storing instructions that, when executed by the one or more processors, cause the computing device to perform one or more of the various methods or techniques described here. The memory may comprise volatile memory (e.g., random access memory (RAM)) and/or non-volatile memory (e.g., a hard or solid-state drive). The memory may comprise a non-transitory computer-readable medium. The computing device may comprise one or more input devices, such as a mouse, a keyboard, or a touch interface. The computing device may comprise one or more output devices, such as a monitor or other video display. The computing device may comprise an audio input and/or output. The computing device may comprise one or more network communication interfaces, such as a wireless transceiver (e.g., Wi-Fi or cellular) or wired network interface (e.g., ethernet). The one or more network communication interfaces may be configured to connect to the network 210.

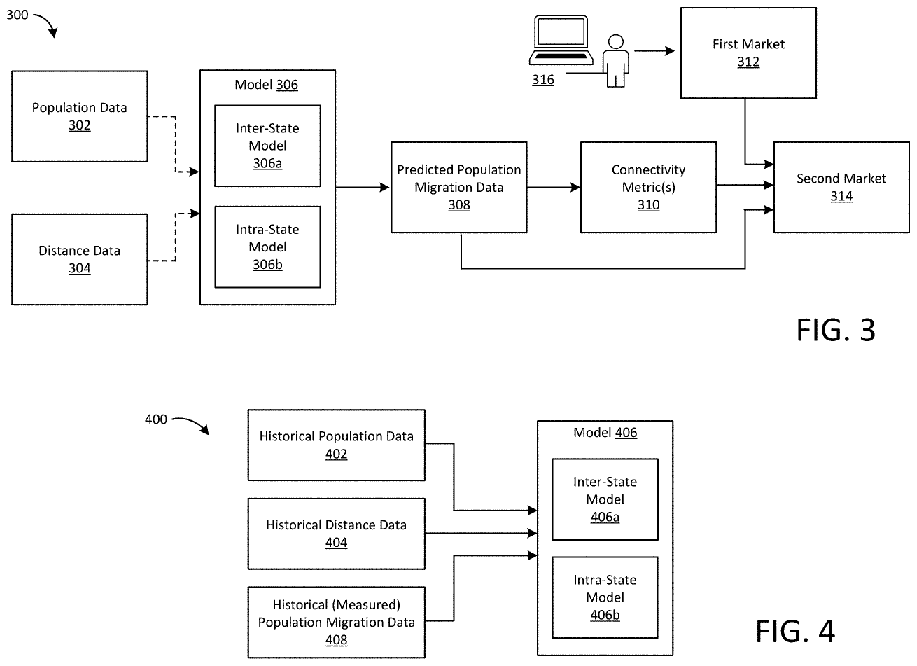

FIG. 3 illustrates an example data flow diagram 300 relating to determining connectivity metrics 310 for a plurality of markets (e.g., geographical areas) based on predicted population migration data 308 for the plurality of markets. In turn, the predicted population migration data 308 is based on population data 302 and distance data 304 for the plurality of markets that are input to a model 306 (additionally or alternatively an inter-state model 306a and/or an intra-state model 306b). The data flow diagram 300 further illustrates determining a second market 314 (e.g., an attractive market) of the plurality of markets based on a first market 312 (e.g., input via a user device 316) of the plurality of markets, the connectivity metric 310 associated with the first market 312, and the predicted population migration (from the predicted population migration data 308) between the first market 312 and the second market 314. The techniques and functions relating to FIG. 3 may be performed by the connectivity analysis system 202 of FIG. 2.

As noted, the population data 302 for the plurality of markets and the distance data 304 for the plurality of markets may be input to the model 306 (and/or the inter-state model 306a or the intra-state model 306b) to determine the predicted population migration data 308 for the plurality of markets. The population data 302 and the distance data 304 may be received by the connectivity analysis system 202 from the data source 204 of FIG. 2, for example.

The population data 302 may indicate the respective populations of the plurality of markets. For the purposes of FIG. 3, the population data 302 may indicate current or near-current populations. The population data 302 may be sourced from a government agency, such as a government census bureau. The population data 302 may also indicate various demographic information for the population of each market, such as age, gender, race, occupation, income, or education level, including the percentage of the population falling within each demographic. For example, the population data 302 may be filtered to indicate the adult population of a market and this number may be used as the effective population of the market.

The distance data 304 may indicate the distances between the markets of the plurality of markets. That is, for each market of the plurality, the distance data 304 indicates the distance between that market and each other market of the plurality. The distances may be measured according to a direct line between markets, such as a straight line connecting the respective population-weighted centroids (centers of mass) of the markets. Additionally or alternatively, the distances may be measured according to real-world travel routes. For example, the driving distance between two markets may be significantly longer than the direct distance if the roadways connecting the two markets must go around a large body of water or undergo the many twists and turns necessary to traverse a mountain or mountain range.

A distance between two markets may be additionally or alternatively classified or otherwise indicated in the distance data 302 as inter-state or intra-state. An intra-state market pair refers to two markets that are located in the same state, while an inter-state market pair refers to two markets that are located in different states. In the event that a market is located in two (or more) separate states, such as the Cincinnati market or the Kansas City market, the market may be classified or identified as belonging to the state with the largest proportion of the market (e.g., with respect to area or population). Similarly, with respect to classifying a pair of markets as either inter-state or intra-state, the pair may be classified as inter-state markets if the entireties of the markets are located in different states or classified as intra-state markets if the entireties of the markets are located in the same state. Or a pair of markets may be classified as inter-state markets if at least half (or other threshold value, e.g., 90%) of each market is located in a different state than the other or classified as intra-state markets if at least half of each market is located in the same state as the other. The use of the term “state” herein is not limited to the states of the United States, but may refer to any designated type of political boundary. For example, “state” may refer to an administrative division or country subdivision, including a province, county, district, region (administrative), territory, prefecture, parish, etc.

Relatedly, the distance between two markets may be classified according to a mode of travel (e.g., automobile, air, train/rail, or boat) and/or the travel time between two markets via the mode of travel. For example, an efficient rail system connecting two markets may facilitate more travel between the markets than would otherwise be the case given the distance between the two markets. As another example, markets on or near a common high-volume highway (e.g., a U.S. interstate highway) may facilitate greater travel between these markets. The rail system and high-volume highway in these examples, or similar, may, in effect, reduce the “distance” between these markets for purposes of the analyses described herein.

Based on the population data 302 and the distance data 304, the model 306 may determine the predicted population migration data 308. That is, the population data 302 and the distance data 304 may be input (indicated by the dashed lines in FIG. 3) to the model 306 to determine the predicted population migration data 308. For each two-market combination within the plurality of markets, the model 306 may determine a predicted population migration between the two markets based on the population of the two markets and the distance between the two markets. The predicted population migration data 308 may represent the bi-directional population flows between two markets as an aggregate. The model 306 shall be described further in relation to FIG. 4.

The model 306 may further comprise the inter-state model 306a and/or the intra-state model 306b. As noted, whether two markets are in the same state or in different states may be one factor affecting the population migration between those markets, with population migrations between intra-state market pairs tending to be greater than they would be if located in different states, all else being equal or substantially equal. It will be understood that references to the model 306 throughout the disclosure apply equally to the inter-state model 306a and the intra-state model 306b, unless clearly indicated otherwise.

As the name suggests, the inter-state model 306a relates to markets that are located in different states. The inter-state model 306a may be configured in a similar manner as the at-large model 306, except that the distance data 304 input includes, or is filtered to include, distance data for only inter-state market pairs. Based on the inter-state distance data input and the population data 302 input, the inter-state model 306a may determine the predicted population migration data 308 (or portion thereof) that indicates the predicted population migrations between the inter-state market pairs. As will be explained in relation to FIG. 4, the inter-state model 306a may be determined based on historical population, distance, and population migration data associated with inter-state markets pairs.

Similarly, the intra-state model 306b relates to markets that are located in the same state. The intra-state model 306b may be configured in a similar manner as the at-large model 306, but with the distance data 304 input including, or filtered to include, distance data for only intra-state markets pairs. Based on the intra-state distance data and the population data 302, the intra-state model 306b may determine the predicted population migration data 308 (or portion thereof) that indicates the predicted population migrations between the intra-state markets pairs. As will be explained in relation to FIG. 4, the intra-state model 306b may be determined based on historical population, distance, and population migration data associated with intra-state markets pairs.

In an example embodiment, the population data 302 and the inter-state portions of the distance data 304 may be input to the inter-state model 306a and the population data 302 and the intra-state portions of the distance data 304 may be input to the intra-state model 306b. Thus, the resultant predicted population migration data 308 may cover the full set of markets and their predicted population migrations, but with the predicted population migration between each inter-state market pair being determined based on, at least in part, the fact that the pair are indeed located in different states and the predicted population migration between each intra-state market pair being determined based on, at least in part, the fact that the pair are indeed located in the same state.

It will be understood that the predicated population migration data 308 (and the connectivity metrics 310 likewise) may be based on the inter- or intra-state relationships between markets via means other than, or in addition to, the distinct inter-state and intra-state models 306a, 306b. For example, the model 306, or other analysis, may determine an initial predicted population migration for a pair of markets (e.g., based only on their respective populations and the distance between the two) and, based on the pair of markets being in different states, apply a different (e.g., different with respect to same-state markets) coefficient to the initial predicted population migration to determine a reduced predicted population migration for the market pair.

The predicted population migration data 308 may be additionally or alternatively based on any market demographic information in the population data 302 (e.g., age, race, gender, income, occupation, education level, or other demographic characteristic). For example, the model 306 may identify a significant proportion of elderly individuals in a market, which may negatively affect the population migration out of the market. The model 306 may apply a different coefficient to any initial predicted population migrations involving this market to adjust these figures downwards. A predicted population migration may be adjusted upwards as well. For example, initial predicted population migrations involving a market with a high average household income may be adjusted to predict greater population migrations.

The predicted population migration data 308 may be additionally or alternatively based on the mode(s) of travel associated with the travel corridor between two markets. For example, such modes of travel may include road, air, rail, or boat. A mode of travel may be further characterized with additional attributes, such as the primary roadway between markets being a high-volume roadway (e.g., an interstate highway). A mode of travel may be further characterized by the effective distance between two markets via that mode of travel. For example, the effective distance between two markets may be measured by the distance traveled over the primary roadway connecting the markets, as opposed to the direct shortest distance between the markets. Effective distance may also be determined according to the realistic travel time between markets. For example, travel between two markets over mountainous terrain may take significantly longer than travel between equally-distanced markets over flat terrain.

One or more connectivity metrics 310 may be determined for the plurality of markets. More particularly, a connectivity metric 310 may be determined for each market of the plurality of markets that represents the overall connectivity of that market in relation to the other markets of the plurality of markets. A connectivity metric 310 for a market may indicate one out of several possible classifications of a market. For example, a connectivity metric 310 may be based on the number of other markets having a predicted population migration with the market that is above a pre-defined population migration threshold (e.g., 2,000).

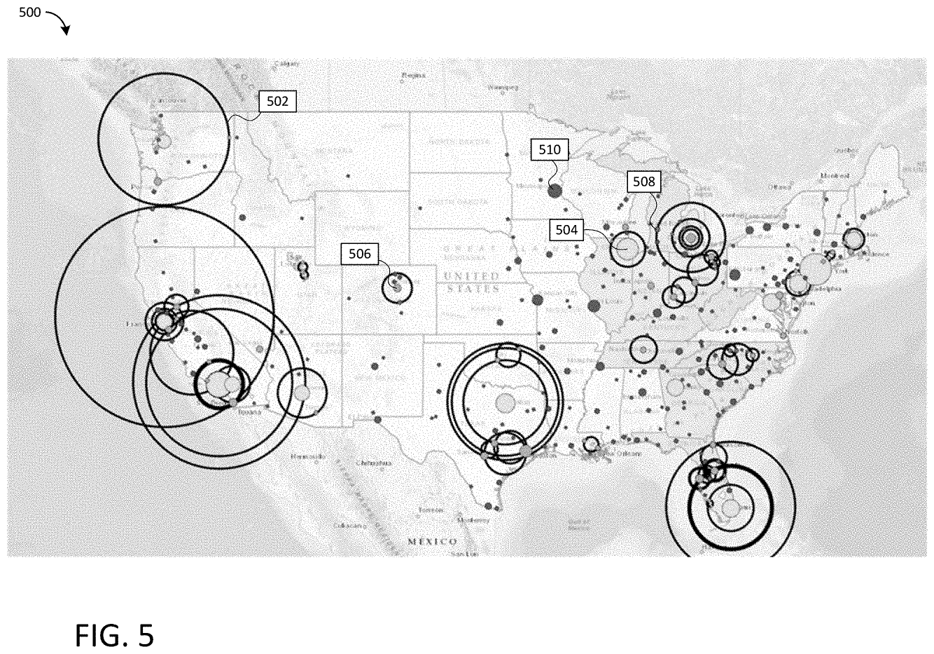

One example technique for determining a connectivity classification may adopt a celestial body taxonomy in which a market is classified into one of four types—a “sun,” a “planet,” a “moon,” or an “asteroid”—by applying six rules (Rules 1-6). The first rule, according to the Rule #, applicable to a market (i.e., celestial body) determines its classification. A sun may correspond to the highest degree of connectivity and an asteroid may correspond to the lowest degree of connectivity. FIG. 5 illustrates an example map diagram 500 of the United States demonstrating such market classifications, with a size of a body/market being proportional to its population.

A pair of markets may be considered in orbit if the predicted population migration between them is greater than a pre-defined population migration threshold (e.g., 2,000 people). The threshold may be applied to the two migration directions separately or in aggregate. An example orbit representation (Seattle, Wash. and Spokane, Wash.) is indicated by reference number 502 in FIG. 5. For visual clarity, FIG. 5 omits orbit representations involving markets in different states.

A market may be classified as a sun if the market is in orbit with a less populous market in a different state (Rule 1). It is possible that two suns may be in orbit with one another sun (i.e., binary suns). An example sun (Chicago, Ill.) is indicated by reference number 504 in FIG. 5.

A market may be classified as a planet if it is in orbit with a sun (Rule 2). A market may also be classified as a planet if it in orbit with a smaller body (e.g., less than half the size of the instant market) and is not in orbit with a larger planet in the same state (Rule 3). Two markets may be considered binary planets if they are in orbit, in the same state, with similar populations (e.g., where the smaller market's population is at least half of the larger market's population) (Rule 5). Some planets may orbit multiple suns and some planets may be in orbit with other planets. An example planet (Denver, Colo.) is indicated by reference number 506 in FIG. 5.

A market may be classified as a moon if it is in orbit with a larger market (e.g., where the smaller market's population is under half of the larger market's population) and is not in orbit with a smaller such market (Rule 3). A market may also be classified as a moon if the market is in orbit with another moon (Rule 4). A moon cannot orbit a sun. A moon can orbit multiple planets. An example moon (Grand Rapids, Mich.) is indicated by reference number 508 in FIG. 5.

A market may be classified as an asteroid if the market is not in orbit with any other market (Rule 6). Asteroids may be close to other markets. Asteroids may have populations that are greater than other markets. An example asteroid (Minneapolis, Minn.) is indicated by reference number 510 in FIG. 5.

In a similar manner as that described above with respect to determining the connectivity metrics 310 based on the predicted population migration data 308, the connectivity metrics 310 may be additionally or alternatively determined based on measured (as opposed to predicted) population migration data. The measured population migration data may be generally analogous to the predicted population migration data 308, aside from it being measured rather than predicted.

With renewed attention to FIG. 3, a user may input the first market 312 via the user device 316. The user device 316 may comprise a desktop computer, a laptop computer, a server, or a mobile device, as some examples. The first market 312 may be a market in which the business entity associated with the user already operates one or more branches, for example. The user may wish to assess the attractiveness (or indeed the unattractiveness) of opening additional branches in one or more other markets. The entity may already operate one or more branches in the second market 314 or may not yet operate any branches in the second market 314.

Rather than being input by a user, the first market 312 may be input automatically. For example, each market in which the business entity operates, including the first market 312, may be input as a batch and a market analogous to the second market 314 may be determined for each input market. In this manner, a complete attractiveness landscape for the business entity's entire branch network may be determined at one time. This automated process may be easily executed additional times, such as after changes in the branch network, shifts in the competitive landscape, or simply at various time intervals.

Based on the predicted population migration data 308, the connectivity metrics 310, and the input first market 312, the second market 314 may be determined. The second market 314 may be determined based, for example, on the predicted population migration data between the first market 312 and the second market 314. The second market 314 may also be determined based on the particular connectivity metric (indicated in the connectivity metrics 310) associated with the second market 314.

The second market 314 may be determined as the market that is most attractive for the business entity to expand into with new branches. For example, a high predicted population migration from the first market 312 to the second market 314 combined with a low connectivity metric for the second market 314 may lead the system to identify the second market 314 as attractive for expansion. The low connectivity metric for the second market 314 may tend to reflect that the contemplated expansion to the second market 314 may be at less risk of competitive disadvantage from competing business entities with presences in other markets. That is, a competing business entity that also expands into the second market 314 may not necessarily have an advantage over the instant business entity, which may otherwise be the case if there was indeed high connectivity between the second market 314 and the competing business entity's already-existing markets. A high predicted population migration between the first market 312 and the second market 314 may also tend towards high attractiveness because current customers of the business entity in the first market 312 may be more likely to remain customers should they move to the second market 314.

Alternatively, depending on the particular implementation, the second market 314 may be determined as the market that is the least attractive for expansion. This may be the case where there is low predicted population migration between the first market 312 and the second market 314 and the second market 314 has a high connectivity metric. For example, if the second market 314 is already highly connected to other markets, competing business entities operating in those other markets may have a competitive advantage in the second market 314 should those competing business entities decide to also expand to the second market 314 and/or already operate branches in the second market 314. For instance, an individual may tend to remain a customer of a business entity when moving from one market to another, if possible.

The system may also determine third, fourth, etc. markets in a similar fashion as the second market 314. The second market 314 along with any additional markets may be determined in a ranked ordering according to attractiveness. A report may be generated indicating the ranked ordering of the determined markets.

FIG. 4 illustrates an example data flow diagram 400 to determine a model 406. The model 406 may be based on historical population data 402, historical distance data 404, and historical population migration data 408 associated with a plurality of markets. The model 406 may be the same as or similar to the model 306 of FIG. 3. For example, the model 406 may be configured to determine predicted population migration data (e.g., the predicted population migration data 308 of FIG. 3) indicating predicted population migrations between the plurality of markets based on population data and distance data associated with the plurality of markets (e.g., the population data 302 and distance data 304 of FIG. 3, respectively). The model 406 may be determined by the connectivity analysis system 202 of FIG. 2 and the historical population data 402, the historical distance data 404, and the historical population migration data 408 may be received from the data source 204 of FIG. 2.

As with the model 306 of FIG. 3, the model 406 may comprise an inter-state model 406a relating to inter-state market pairs and an intra-state model 406b relating to intra-state market pairs. The inter-state model 406a and the intra-state model 406b may be the same as or similar to FIG. 3's inter-state model 306a and intra-state model 306b, respectively. Thus, the inter-state model 406a may be configured to determine predicted population migration data for inter-state market pairs. Likewise, the intra-state model 406b may be configured to determine predicted population migration data for intra-state market pairs. In a similar manner as with the model 406, the inter-state model 406a may be determined based on the historical population data 402, portions of the historical distance data 404 relating to inter-state market pairs, and portions of the historical population migration data 408 relating to inter-state market pairs. The intra-state model 406b may be determined similarly except with respect to intra-state market pairs.

The historical population data 402 may indicate the historical populations of the respective markets of the plurality of markets. The historical population for a market may comprise a series of populations of the market at various set time intervals (e.g., every year, every five years, etc.), which may or may not include a current population. The historical population data 402 may be similar to the population data 302 of FIG. 3 except that it comprises past, historical populations.

The historical distance data 404 may indicate the historical distances between each 2-market combination in the plurality of markets. Save for any exceptional circumstances, such as redefining a market, the historical distance data 404 may be the same as the distance data 304 of FIG. 3.

The historical population migration data 408 may comprise historical population migrations between each 2-market combination in the plurality of markets. The historical population migrations may be measured rather than predicted. Like the historical population data, the historical population migration data 408 may comprise a series of population migrations at various set time intervals that, preferably, correspond to those in the historical population data 402. The historical population migration data 408 may be determined from government records made available to the public, such as that provided by the U.S. Internal Revenue Service or Census Bureau.

The historical population data 402, historical distance data 404, and historical population migration data 408 may represent markets that are different, at least in part, from those represented in the population data 302 and distance data 304.

The model 406 (and the inter-state and intra-state models 406a, 406b similarly) may be determined via regression analysis. The regression analysis may be performed on respective populations of two markets of the plurality of markets and a distance between the two markets to determine a predicted population migration between the two markets. As an example, a predicted population migration between market A and market B may be determined, at least for purposes of generating the model 406, according to Eq. (1) below.

$$Predicted population migration = C * \frac{( population of A * population of B )}{{( distance between A and B )}^{2}} \qquad Eq ( 1 )$$

The distance between market A and market B are measured from their respective centers. C is a coefficient of the prediction term.

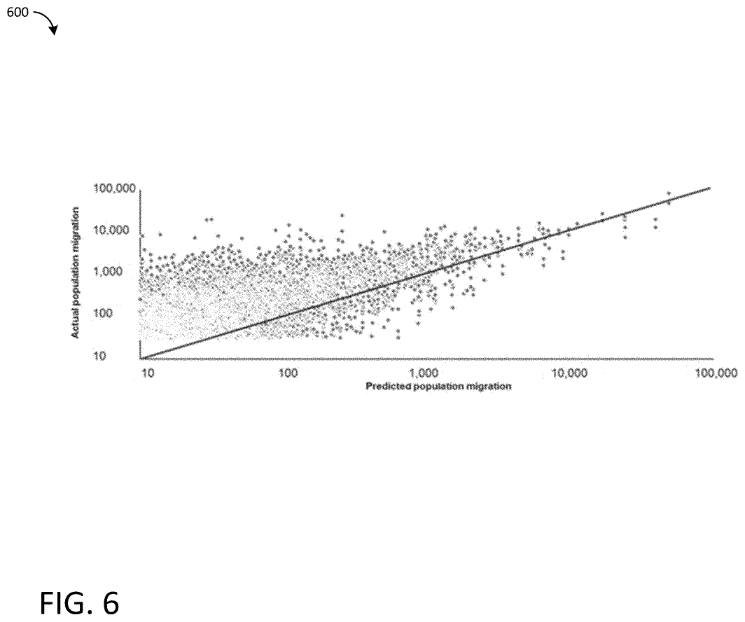

FIG. 6 illustrates an example graph 600 for regression analysis that is based on sample actual (measured) population migration data and corresponding predicted population migration data. The actual population migrations on the Y axis are plotted against corresponding predicted population migrations on the X axis. The predicted population migrations represented in FIG. 6 are determined according to Eq. (1). The regression analysis associated with the graph 600 yields an R² of 0.582 with N=11,256.

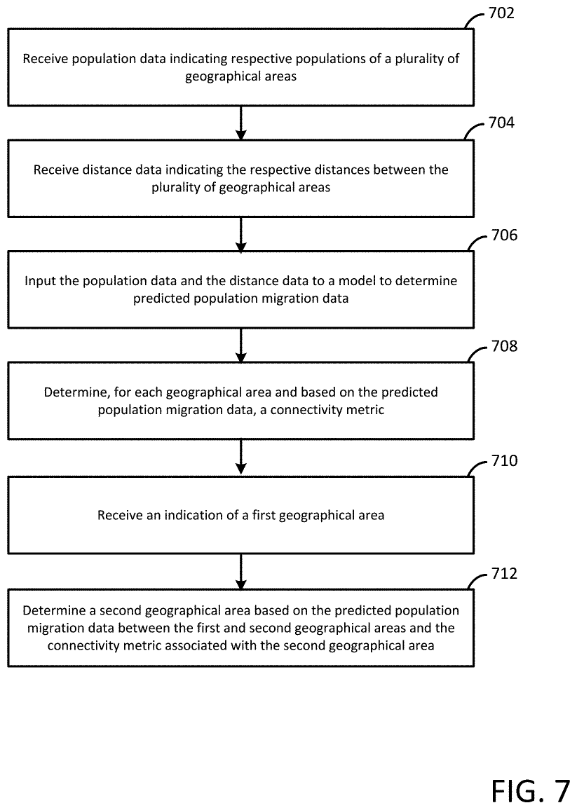

FIG. 7 illustrates a method flow diagram. At step 702, population data (e.g., the population data 302 of FIG. 3) indicating respective populations of a plurality of geographical areas (e.g., markets) may be received. Said plurality of geographical areas may be the same as or similar to the plurality of markets referred to in relation to FIG. 3.

At step 704, distance data (e.g., the distance data 304 of FIG. 3) indicating the respective distances between the plurality of geographical areas may be received. The distances may represent a direct, shortest path distance. Additionally or alternatively, the distances may represent “effective” or adjusted distance that more realistically represents the time or effort required to travel between two geographical areas. For example, an effective distance may be determined by adjusting the direct distance according to mode(s) of travel (e.g., road, air, rail, or boat) between the geographical areas, an actual measured distance that must be traversed (i.e., traversal distance) to travel between geographical areas (e.g., due to winding or indirect roads), or an average time required to travel between geographical areas (i.e., travel time).

At step 706, the population data and the distance data may be input to a model (e.g., one or more of the models 306, 306a, or 306b of FIG. 3 or the models 406, 406a, or 406b of FIG. 4) to determine predicted population migration data (e.g., the predicted population migration data 308 of FIG. 3) indicating predicted population migrations between the plurality of geographical areas. The predicted population migrations may be additionally or alternatively determined based on the respective states of the geographical areas. For example, the model may identify that a first geographical area of the plurality is located in one state and a second geographical area of the plurality is located in another state (e.g., via comparing the states) and determine the predicted population migration between these two geographical areas accordingly. In this example, the predicted population migration between these two geographical areas may be less than if they were located in the same state.

The predicted population migration data may be additionally or alternatively determined based on respective effective adjusted distances between the plurality of geographical areas. The predicted population migration data may be additionally or alternatively determined based on respective demographic characteristics of the plurality of geographical areas. For example, the predicted population migration data may be determined based on the respective average incomes of the plurality of geographical areas.

The model may be determined based on historical population data indicating respective historical populations of a historical plurality of geographical areas, historical distance data indicating the respective distances between the historical plurality of geographical areas, and historical population migration data indicating respective historical population migrations between the historical plurality of geographical areas. The model may be determined via regression analysis on respective populations of two geographical areas and a distance between the two geographical areas to determine a predicted population migration between the two geographical areas, as discussed in relation to FIG. 6.

Step 706 (e.g., the inputting the population data and the distance data to the model to determine the predicted population migration data) may additionally or alternatively include inputting the population data and a portion of the distance data associated with a plurality of intra-state pairs of geographical areas, of the plurality of geographical areas, to an intra-state model (e.g., the intra-state model 306b of FIG. 3 or the intra-state model 406b of FIG. 4) to determine predicted intra-state population migration data associated with the intra-state pairs of geographical areas. The predicted intra-state population migration data may indicate the predicted population migration between each of the intra-state pairs of geographical areas. In an intra-state pair of geographical areas, the geographical areas are located in the same state. Step 708 (e.g., the inputting the population data and the distance data to the model to determine the predicted population migration data) may additionally or alternatively include inputting the population data and a portion of the distance data associated with a plurality of inter-state pairs of geographical areas, of the plurality of geographical areas, to an inter-state model (e.g., the inter-state model 306a of FIG. 3 or the inter-state model 406a of FIG. 4) to determine predicted inter-state population migration data associated with the inter-state pairs of geographical areas. The predicted inter-state population migration data may indicate the predicted population migration between each of the inter-state pairs of geographical areas. In an inter-state pair of geographical areas, the geographical areas are located in different states. The predicted population migration data may comprise the predicted intra-state population migration data and the predicted inter-state population migration data.

The intra-state model may be determined in a similar manner as the model except that it may be based on historical distance data for intra-state pairs of geographical areas (rather than historical distance data for both intra-state and inter-state pairs of geographical areas) and historical population migration data for intra-state pairs of geographical areas (rather than historical population migration data for both intra-state and inter-state pairs of geographical areas). Likewise, the inter-state model may be determined in a similar manner as the model except that it may be based on historical distance data for inter-state pairs of geographical areas (rather than historical distance data for both intra-state and inter-state pairs of geographical areas) and historical population migration data for inter-state pairs of geographical areas (rather than historical population migration data for both intra-state and inter-state pairs of geographical areas).

At step 708, for each geographical area of the plurality of geographical areas, a connectivity metric (e.g., the connectivity metric(s) 310 of FIG. 3) may be determined that represents the connectivity of the geographical area with respect to the other geographical areas of the plurality of geographical areas. The connectivity metric for each geographical area may be further based on a distance between the geographical area and at least one other geographical areas of the plurality of geographical areas. The connectivity metric for each geographical area may be further based on the predicted population migration between the geographical area and at least one other geographical area of the plurality of geographical areas. The connectivity metric for each geographical area may be further based on the population of the geographical area and a population of at least one other geographical area of the plurality of geographical areas.

A connectivity metric may be classified according to two or more classifications, such as those described in relation to FIG. 5. The classification of a geographical areas may be determined according to a plurality of rules. The plurality of rules may classify a geographical area based on identifying other geographical areas with a predicted population migration with the instant geographical area that is above a pre-defined threshold. The plurality of rules may classify a geographical area based on the state of the geographical area compared to the respective states of one or more of the other geographical areas. The plurality of rules may classify a geographical area based on the classification of one or more other geographical areas. The classifications may be in a ranked ordering with respect to connectivity.

In an embodiment that incorporates the inter-state model and the intra-state model and/or the distinct predicted intra-state population migration data and predicted inter-state population migration data, as described above in relation to step 706, determining the connectivity metric for each geographical area may be further based on the predicted intra-state population migration data and the inter-state predicted population migration data. For example, determining a connectivity metric for a particular geographical area may be based on a predicted population migration, indicated in the predicted inter-state population migration data, with another geographical area located in a different state. Additionally, determining the connectivity metric for this particular geographical area may be further based on a predicted population migration, indicated in the intra-state population migration data, with another geographical area located in the same state.

At step 710, an indication of a first geographical area (e.g., the first market 312 of FIG. 3) of the plurality of geographical areas may be received. The first geographical area may be input by a user, for example. The first geographical area may be a geographical area in which an instant business entity operates one or more branches. The business entity may wish to assess the attractiveness of one or more of the other geographical areas to expand its branch network.

At step 712, a second geographical area (e.g., the second market 314 of FIG. 3) of the plurality of geographical areas may be determined based on the predicted population migration data between the first geographical area and the second geographical area and the connectivity metric associated with the second geographical area. A report may be generated indicating the second geographical area. The second geographical area may be the geographical area of the plurality of geographical areas that is determined to be the most attractive for expansion by the business entity. Accordingly, the business entity may open a branch in the second geographical area. Conversely, depending on the particular implementation, the second geographical area may be the geographical area of the plurality of geographical areas that is determined to be the least attractive for expansion.

In an embodiment that incorporates the inter-state model and the intra-state model and/or the distinct predicted intra-state population migration data and predicted inter-state population migration data, as described above in relation to step 706, the second geographical area may be additionally or alternatively determined based on the predicted intra-state population migration data and/or the predicted inter-state population migration data. For example, if the first geographical area and the second geographical area are located in the same state, the second geographical area may be additionally or alternatively determined based on the predicted intra-state population migration data (e.g., the predicted population migration between the first and second geographical areas indicated in the predicted intra-state population migration data). If the first geographical area and the second geographical area are located in different states, the second geographical area may be additionally or alternatively determined based on the predicted inter-state population migration data (e.g., the predicted population migration between the first and second geographical areas indicated in the predicted inter-state population migration data).

The method may further determine a third (or more) geographical area of the plurality of geographical areas in a similar manner as the second geographical area. For example, the third geographical area may be determined based on the predicted population migration between the first geographical area and the third geographical area and the connectivity metric associated with the third geographical area. The second and third geographical areas may be ranked according to attractiveness for branch network expansion. A report may be generated indicating this ranked ordering.

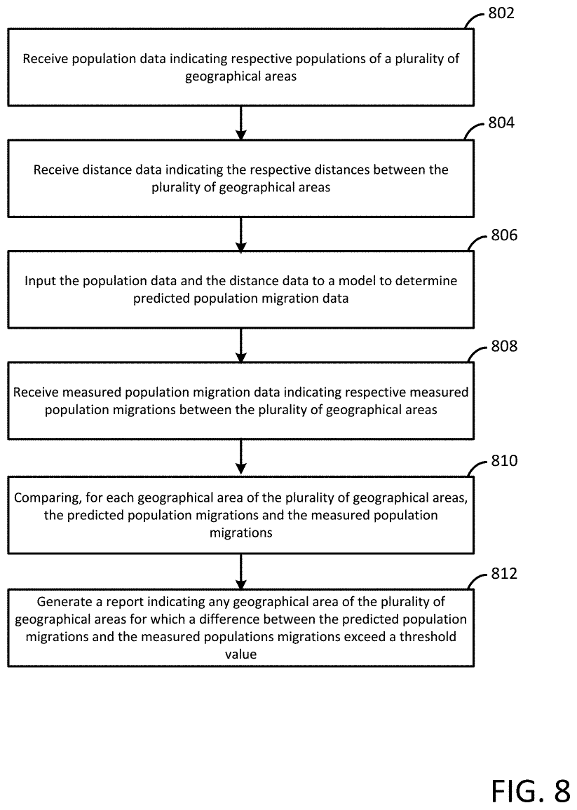

FIG. 8 illustrates a method flow diagram. The method may be used to identify one or more “magnet” geographical areas out of a plurality of geographical areas (e.g., the plurality of markets referred to in relation to FIG. 3). A magnet geographical area may refer to a geographical area that has an unexpected number of population migrations, particularly with respect to inbound population migrations to the magnet geographical area. While the method described in relation to FIG. 7 may be reliably used to assess an attractiveness of one or more geographical areas for branch network management, it may be useful to identify any outlier magnet geographical areas for further analysis.

At step 802, population data (e.g., the population data 302 of FIG. 3) indicating respective populations of a plurality of geographical areas (e.g., markets) may be received. Step 802 may be performed in a similar manner as step 702 of FIG. 7.

At step 804, distance data (e.g., the distance data 304 of FIG. 3) indicating the respective distances between the plurality of geographical areas. Step 804 may be performed in a similar manner as step 704 in FIG. 7. The distances indicated in the distance data may represent the direct, shortest-path distances between geographical areas or the distances indicated in the distance data may represent adjusted “effective” distances between geographical areas.

At step 806, the population data and the distance data may be input to a model (e.g., one or more of the models 306, 306a, or 306b of FIG. 3 or the models 406, 406a, or 406b of FIG. 4) to determine predicted population migration data (e.g., the predicted population migration data 308 of FIG. 3) indicating predicted population migrations between the plurality of geographical areas. Step 806 may be performed in a similar manner as step 706 of FIG. 7. The model may determine the predicted population migration data further based on the respective states of the plurality of geographical areas. For example, two geographical areas in the same state may have greater population migration than if they were in different states. The model may determine the predicted population migration data further based on the adjusted “effective” distances rather than the direct distances between geographical areas. The model may determine the predicted population migration data further based on respective demographic characteristics of the plurality of geographical areas.

In a similar manner as step 706 of FIG. 7, step 806 may additionally or alternatively include inputting the population data and a portion of the distance data associated with a plurality of intra-state pairs of geographical areas, of the plurality of geographical areas, to an intra-state model (e.g., the intra-state model 306b of FIG. 3 or the intra-state model 406b of FIG. 4) to determine predicted intra-state population migration data associated with the intra-state pairs of geographical areas. Step 806 may additionally or alternatively include inputting the population data and a portion of the distance data associated with a plurality of inter-state pairs of geographical areas, of the plurality of geographical areas, to an inter-state model (e.g., the inter-state model 306a of FIG. 3 or the inter-state model 406a of FIG. 4) to determine predicted inter-state population migration data associated with the inter-state pairs of geographical areas. The predicted population migration data may comprise the predicted intra-state population migration data and the predicted inter-state population migration data.

At step 808, measured (e.g., actual) population migration data indicating respective measured population migrations between the plurality of geographical areas may be received. The measured population migration data may be received from (or otherwise derived from) one or more government agencies, for example.

In an embodiment that incorporates the inter-state model and the intra-state model and/or the distinct predicted intra-state population migration data and predicted inter-state population migration data, as described above in relation to step 806, measured intra-state population migration data for intra-state pairs of geographical areas and measured inter-state population migration data for inter-state pairs of geographical areas may be received. The measured population migration data may comprise the measured intra-state population migration data and the measured inter-state population migration data.

At step 810, for each geographical area of the plurality of geographical areas, one or more (e.g., all) predicted population migrations associated with the geographical area and one or more (e.g., all) corresponding measured population migrations associated with the geographical area may be compared. Comparing the one or more predicted population migrations and the one or more corresponding measured population migrations may comprise determining the respective difference(s) between the one or more predicted population migrations and the one or more corresponding measured population migrations. The difference(s) may be compared to a pre-defined threshold value. It may be determined that the difference(s) exceed the threshold value.

In an embodiment that incorporates the inter-state model and the intra-state model and/or the distinct predicted intra-state population migration data and predicted inter-state population migration data, as described in relation to step 806, step 810 may be performed as described above, but with comparing the predicted intra-state population migrations to the corresponding measured intra-state population migrations and comparing the predicted inter-state population migrations to the corresponding measured inter-state population migrations.

At step 812, a report may be generated that indicates any geographical area of the plurality of geographical areas for which a difference between the one or more predicted population migrations (and/or predicted intra-state or inter-state population migrations) associated with the geographical area and the one or more corresponding measured population migrations (and/or measured intra-state or inter-state population migrations) associated with the geographical area exceeds the threshold value. Any such geographical areas may be considered as magnet geographical areas.

The geographical areas for which the aforementioned difference between predicted and measured population migrations exceeds the threshold value may be indicated in the report in a ranked ordering. For example, the ranked ordering may be according to the aforementioned difference for each geographical graphical area. A greater difference may reflect a greater degree of “magnetism” of the geographical area. The geographical areas indicated in the report may be further studied by skilled analysts associated with the relevant business entity to identify any factors that may cause, at least in part, the geographical areas to exhibit this trait. For example, such factors may include a desirable weather or climate, tax benefits, above average economic growth, a concentration of a particular industry (e.g., high-tech or entertainment), or even various cultural attributes of a geographical area. The particular factors identified in a magnet geographical area may be used to help predict population migration and/or connectivity in other geographical areas that have these factors in common.

One or more of the above factors identified as causing, at least in part, a geographical area to exhibit greater population migrations than predicted may serve as a basis for updating the model referred to above in step 806 for determining predicted population migration data (e.g., one or more of the models 306, 306a, 306b of FIG. 3 or the models 406, 406a, 406b of FIG. 4). For example, such a factor (preferably a factor that is quantifiable across the plurality of geographical areas) may be added as an input to the model to improve the predictive power of the predicted population migrations.

Additionally or alternatively, determining a magnet geographical area may incorporate connectivity metrics for the plurality of geographical areas. For example, for each geographical area of the plurality of areas and based on the predicted population migration data, a predicted connectivity metric may be determined. The predicted connectivity metric for a geographical area may represent the overall connectivity of the geographical area with respect to the other geographical areas. The predicted connectivity metrics may be the same as or similar to the connectivity metrics 310 of FIG. 3. In addition, for each geographical area of the plurality of geographical areas and based on the measured population migration data, a measured connectivity metric may be determined. The measured connectivity metric for a geographical area may represent the measured overall connectivity of the geographical area with respect to the other geographical areas. The measured connectivity metrics may be similar to the connectivity metric 310 of FIG. 3 except that it is based on measured population migration data (e.g., the historical population migration data 408 of FIG. 4) rather than predicted population migration data (e.g., the predicted population migration data 308 of FIG. 3).

For each geographical area of the plurality of geographical areas, the predicted connectivity metric and the measured connectivity metric may be compared to one another. For each geographical area, a difference between the predicted connectivity metric and the measured connectivity metric may be determined and this difference may be compared to a pre-defined connectivity metric threshold value. Those geographical areas for which the difference between their measured connectivity metric and their predicted connectivity metric exceeds the connectivity metric threshold value may be indicated in the above-mentioned report or by another (generated) report. These geographical areas may be indicated in the report in a ranked ordering according to their respective differences between measured and predicted connectivity metrics.

One skilled in the art will appreciate that the systems and methods disclosed herein may be implemented via a computing device that may comprise, but are not limited to, one or more processors, a system memory, and a system bus that couples various system components including the processor to the system memory. In the case of multiple processors, the system may utilize parallel computing.

For purposes of illustration, application programs and other executable program components such as the operating system are illustrated herein as discrete blocks, although it is recognized that such programs and components reside at various times in different storage components of the computing device and are executed by the data processor(s) of the computer. An implementation of service software may be stored on or transmitted across some form of computer-readable media. Any of the disclosed methods may be performed by computer-readable instructions embodied on computer-readable media. Computer-readable media may be any available media that may be accessed by a computer. By way of example and not meant to be limiting, computer-readable media may comprise “computer storage media” and “communications media.” “Computer storage media” comprise volatile and non-volatile, removable and non-removable media implemented in any methods or technology for storage of information such as computer-readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer. Application programs and the like and/or storage media may be implemented, at least in part, at a remote system.

As used in the specification and the appended claims, the singular forms “a,” “an” and “the” include plural referents unless the context clearly dictates otherwise. Ranges may be expressed herein as from “about” one particular value, and/or to “about” another particular value. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect.

It will be apparent to those skilled in the art that various modifications and variations may be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising:
receiving population data indicating respective populations of a plurality of geographical areas;
receiving distance data indicating the respective distances between the plurality of geographical areas;
inputting the population data and the distance data to a model to determine predicted population migration data indicating predicted population migrations between the plurality of geographical areas;
determining, for each geographical area of the plurality of geographical areas and based on the predicted population migration data, a connectivity metric representing connectivity of the geographical area with respect to the other geographical areas of the plurality of geographical areas;
receiving an indication of a first geographical area of the plurality of geographical areas; and
determining a second geographical area of the plurality of geographical areas based on the predicted population migration between the first geographical area and the second geographical area and the connectivity metric associated with the second geographical area.

2. The method of claim 1, further comprising determining the model based on:
historical population data indicating respective historical populations of a historical plurality of geographical areas,
historical distance data indicating respective distances between the historical plurality of geographical areas, and
historical population migration data indicating respective historical population migrations between the historical plurality of geographical areas.

3. The method of claim 2, wherein determining the model comprises performing a regression analysis on respective populations of two geographical areas and a distance between the two geographical areas to determine the predicted population migration between the two geographical areas.

4. The method of claim 1, wherein the connectivity metric for each geographical area of the plurality of geographical areas is further based on a state of the geographical area, and the determining the second geographical area comprises comparing a state of the first geographical area with a state of the second geographical area.

5. The method of claim 1, wherein the connectivity metric for each geographical area of the plurality of geographical areas is further based on a distance between the geographical area and at least one other geographical area of the plurality of geographical areas.

6. The method of claim 1, wherein the connectivity metric for each geographical area of the plurality of geographical areas is further based on the predicted population migration between the geographical area and at least one other geographical area of the plurality of geographical areas.

7. The method of claim 1, wherein the connectivity metric for each geographical area of the plurality of geographical areas is further based on the population of the geographical area and a population of at least one other geographical area of the plurality of geographical areas.

8. The method of claim 1, wherein:
the inputting the population data and the distance data to the model to determine the predicted population migration data comprises:
inputting the population data and a portion of the distance data associated with a plurality of intra-state pairs of geographical areas, of the plurality of geographical areas, to a second model to determine predicted intra-state population migration data associated with the plurality of intra-state pairs of geographical areas, wherein the geographical areas of each intra-state pair of geographical areas of the plurality of intra-state geographical areas are located in the same state as one another, and
inputting the population data and a portion of the distance data associated with a plurality of inter-state pairs of geographical areas, of the plurality of geographical areas, to a third model to determine predicted inter-state population migration data associated with the plurality of inter-state pairs of geographical areas, wherein the geographical areas of each inter-state pair of geographical areas of the plurality of inter-state geographical areas are located in different states from one another, and
the determining the connectivity metric for each geographical areas of the plurality of geographical areas is further based on the predicted intra-state population migration data and the predicted inter-state population migration data.

9. The method of claim 8, further comprising:
determining the second model based on:
historical intra-state population data indicating respective historical populations of a historical intra-state plurality of geographical areas, wherein each intra-state pair of geographical areas, of the historical intra-state plurality of geographical areas, are located in the same state as one another,
historical intra-state distance data indicating respective distances between each intra-state pair of geographical areas of the historical intra-state plurality of geographical areas, and
historical intra-state population migration data indicating respective historical population migrations between each intra-state pair of geographical areas of the historical instar-state plurality of geographical areas; and
determining the third model based on:
historical inter-state population data indicating respective historical populations of a historical inter-state plurality of geographical areas, wherein each inter-state pair of geographical areas, of the historical inter-state plurality of geographical areas, are located in different states from one another,
historical inter-state distance data indicating respective distances between each inter-state pair of geographical areas of the historical inter-state plurality of geographical areas, and
historical inter-state population migration data indicating respective historical population migrations between each inter-state pair of geographical areas of the historical inter-state plurality of geographical areas.

10. The method of claim 1, further comprising:
determining a third geographical area of the plurality of geographical areas based on the predicted population migration between the first geographical area and the third geographical area and the connectivity metric associated with the third geographical area; and
generating a report comprising a ranked ordering of the second geographical area and the third geographical area.

11. The method of claim 1, wherein the determining the connectivity metric comprises:
for each geographical area of the plurality of geographical areas, classifying the geographical area into a classification of a plurality of classifications, wherein the plurality of classifications are ranked according to connectivity with other geographical areas of the plurality of geographical areas.

12. The method of claim 11, wherein the classifying a geographical area into a classification of the plurality of classifications comprises:
applying a plurality of ranked rules to the geographical area based on the distances between the geographical area and the other geographical areas of the plurality of geographical areas, a state of the geographical area relative to respective states of the other geographical areas of the plurality of geographical areas, and the predicted population migration between the geographical area and the other geographical areas of the plurality of geographical areas.

13. The method of claim 1, wherein the receiving the indication of the first geographical area comprises receiving, from a user device and based on a user input to the user device, the indication of the first geographical area comprises.

14. The method of claim 1, wherein the respective distances between the plurality of geographical areas comprise determined effective distances, wherein a determined effective distance is based on at least one of a mode of travel between geographical areas, a measured traversal distance between geographical areas, or an average travel time between geographical areas.

15. The method of claim 1, wherein, for each geographical area of the plurality of geographical areas, the connectivity metric is further based on a demographic characteristic of the geographical area.

16. A method comprising:
receiving population data indicating respective populations of a plurality of geographical areas;
receiving distance data indicating the respective distances between the plurality of geographical areas;
inputting the population data and the distance data to a model to determine predicted population migration data indicating predicted population migrations between the plurality of geographical areas;
receiving measured population migration data indicating respective measured population migrations between the plurality of geographical areas;
comparing, for each geographical area of the plurality of geographical areas, one or more predicted population migrations associated with the geographical area and one or more corresponding measured population migrations associated with the geographical area; and
generating a report indicating any geographical area of the plurality of geographical areas for which a difference between the one or more predicted population migrations associated with the geographical area and the one or more corresponding measured population migrations associated with the geographical area exceeds a threshold value.

17. The method of claim 16, further comprising:
determining, for a pair of geographical areas of the plurality of geographical areas, a difference between the predicted population migration for the pair of geographical areas and the measured population migration for the pair of geographical areas;
comparing the difference between the predicted population migration for the pair of geographical areas and the measured population migration for the pair of geographical areas to the threshold value;
determining that the difference between the predicted population migration for the pair of geographical areas and the measured population migration for the pair of geographical areas exceeds the threshold value; and
causing the pair of geographical areas to be indicated in the report.

18. The method of claim 16, further comprising:
determining, for each geographical area of the plurality of geographical areas and based on the predicted population migration data, a predicted connectivity metric representing predicted overall connectivity of the geographical area with respect to the other geographical areas of the plurality of geographical areas;
determining, for each geographical area of the plurality of geographical areas and based on the measured population migration data, a measured connectivity metric representing measured overall connectivity of the geographical area with respect to the other geographical areas of the plurality of geographical areas;
comparing, for each geographical area of the plurality of geographical areas, the predicted connectivity metric and the measured connectivity metric; and
generating a report indicating any geographical area of the plurality of geographical areas for which a difference between the predicted connectivity metric and the measured connectivity metric exceed a connectivity metric threshold value.

19. The method of claim 16, wherein the predicted population migration data is further based on respective states of the plurality of geographical areas.

20. A device comprising:
one or more processors; and
memory storing instructions that, when executed by the one or more processors, cause the device to:
receive population data indicating respective populations of a plurality of geographical areas;
receive distance data indicating the respective distances between the plurality of geographical areas;
input the population data and the distance data to a model to determine predicted population migration data indicating predicted population migrations between the plurality of geographical areas;
determine, for each geographical area of the plurality of geographical areas and based on the predicted population migration data, a connectivity metric representing connectivity of the geographical area with respect to the other geographical areas of the plurality of geographical areas;
receive an indication of a first geographical area of the plurality of geographical areas; and
determine a second geographical area of the plurality of geographical areas based on the predicted population migration between the first geographical area and the second geographical area and the connectivity metric associated with the second geographical area.
